(19) United States
(12) Patent Application Publication
(10) Pub. No.: US 2025/0165301 A1
(43) Pub. Date: May 22, 2025

(54) EFFICIENT EXECUTION OF MACHINE LEARNING MODELS IN HETEROGENEOUS PROCESSING ENVIRONMENTS

(71) Applicant: QUALCOMM Incorporated, San Diego, CA (US)

(72) Inventors: Krishna Raju VEGIRAJU, Hyderabad (IN); Siva Rama Krishna Reddy BOGI REDDY, Bengaluru (IN); Adarsh GOLIKERI, Bengaluru (IN); Hongqiang WANG, San Diego, CA (US)

(21) Appl. No.: 18/512,330

(22) Filed: Nov. 17, 2023

(51) Int. Cl. G06F 9/50; G06F 16/901

(52) U.S. Cl. CPC G06F 9/5066; G06F 16/9024

(57) ABSTRACT

Certain aspects provide techniques and apparatuses for efficient operation of a machine learning model in a heterogeneous computing environment. An example method includes partitioning a graph representing a machine learning model into a plurality of subgraphs. Each subgraph generally represents a portion of the machine learning model. For each subgraph, a plurality of execution paths are simulated based on permutations of using different processing unit types to execute portions of the subgraph and starting with each input source processing unit type selected from the different processing unit types, and an execution path having a lowest cost is selected from the plurality of execution paths. The machine learning model is implemented based on the selected execution path for each subgraph.

### INTRODUCTION

Aspects of the present disclosure relate to machine learning models, and more specifically to efficient execution of machine learning models in heterogeneous environments.

Machine learning models, such as convolutional neural networks, transformer neural networks, and the like, are used for various tasks, such as object detection in visual content, segmentation of visual content, processing data having objects with different dimensions, generating natural language responses to natural language queries, and the like. In order to perform these tasks, these machine learning models may be trained to perform various operations internally (e.g., to map input data into representations in a latent space based on which an inference can be performed, to project inputs into tokens (e.g., key, query, and value tokens in a transformer neural network), apply an activation function to data generated by the machine learning model, etc.). These operations may vary in complexity, from relatively simple mathematical operations (e.g., addition, multiplication, etc.) to complex mathematical operations that involve significant amounts of processor time and memory utilization.

These machine learning models may be deployed to devices having various processors which can perform operations of varying complexity with varying power utilization and performance characteristics. For example, these devices may include one or more of a central processing unit (CPU), a graphics processing unit (GPU), a tensor processing unit (TPU), a neural processing unit (NPU), or the like, and each of these processing units may include one or more processing cores which can be used to perform different operations using a machine learning model. However, different portions of the machine learning model may have different performance characteristics such that some processing units do not provide sufficient computing resources to perform these operations or to perform these operations at a defined level of performance, while higher performance processing units may perform these operations quickly, but without using the full capabilities of these processing units.

### BRIEF SUMMARY

Certain aspects of the present disclosure generally relate to efficient operation of machine learning models in a heterogeneous processing environment including a plurality of types of processing units having different performance characteristics.

Certain aspects of the present disclosure provide a method that generally includes partitioning a graph representing a machine learning model into a plurality of subgraphs. Each subgraph generally represents a portion of the machine learning model. For each subgraph, a plurality of execution paths are simulated based on permutations of using different processing unit types to execute portions of the subgraph and starting with each input source processing unit type selected from the different processing unit types, and an execution path having a lowest cost is selected from the plurality of execution paths. The machine learning model is implemented based on the selected execution path for each subgraph.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example partitioning of a machine learning model into a plurality of subgraphs, according to aspects of the present disclosure.

FIG. 2 illustrates an example modification of a subgraph representing a portion of a machine learning model, according to aspects of the present disclosure.

FIG. 3 illustrates an example simulation of execution paths for a subgraph representing a portion of a machine learning model, according to aspects of the present disclosure.

FIG. 4 illustrates an example of selecting an execution path from simulations of execution paths through a plurality of subgraphs representing different portions of a machine learning model, according to aspects of the present disclosure.

FIG. 5 illustrates example operations for efficiently executing operations using a machine learning model in a heterogeneous processing environment, according to aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for efficiently executing operations using a machine learning model in a heterogeneous processing environment. As used herein, a heterogeneous processing environment generally refers to a computing environment in which multiple types of processing units with different performance characteristics and processing capabilities can be used to perform operations using a machine learning model (e.g., training and/or inferencing using a machine learning model).

A computing device on which machine learning models execute generally includes many types of processors. For example, such a computing device may include a central processing unit (CPU), a graphics processing unit (GPU), a neural processing unit (NPU), and/or other processing units which can perform operations on input data and generate an output based on these operations. Each processing unit in a computing device may have different performance characteristics, power utilization profiles, and the like. For example, a CPU or other general-purpose processing unit may be able to execute a wide variety of operations (e.g., integer operations, floating-point operations, matrix operations, etc.), but may not provide the highest level of performance for at least some of these operations amongst the processing units included in the computing device. Other, more specialized processing units, such as a GPU or NPU, may perform specific operations with a high level of performance (e.g., using the least amount of time), but may not be fully utilized when performing other operations. In such a case, the processing resources used by a specialized processing unit may be wasted when performing operations that could also be performed with a sufficient level of performance by one or more other processing units.

To optimize, or at least improve, the performance of operations using machine learning models, different portions of the machine learning model may be executed by different processing units based on the complexity involved in executing particular operations and the performance characteristics of the different processing units in a heterogeneous processing environment. While dividing a machine learning model into groups of operations that are performed on different processing units in a heterogeneous processing environment may allow for appropriate processing units to be used in executing these different operations, such division of operations and the execution of different operations on different processing units may impose various overhead costs that may degrade the overall performance of a computing system. For example, when an operation is migrated from a first processing unit to a second processing unit, a context switching penalty may be incurred. This context switching penalty generally includes the time during which data stored in on-processing-unit memory (e.g., caches, registers, etc.) is migrated from the first processing unit to the second processing unit. Until the data is migrated to the second processing unit, operations may not be performed, as the data based on which these operations are performed may not be present in memory. In another example, different processing units may have different amounts of on-processing-unit memory. In a scenario in which the second processing unit does not have sufficient on-processing-unit memory in order to store the data based on which operations are to be performed, performance may be negatively impacted by memory thrashing, a phenomenon in which data is repeatedly swapped between on-processor and off-processor memory in order to perform an operation, with each swap incurring a performance penalty.

Various techniques can be used to schedule the execution of portions of a machine learning model on different processing units in a heterogeneous computing system to mitigate performance degradation caused by the migration of operations to and from different processing units in a heterogeneous processing environment. In one example, fixed priority-based scheduling may be used in which different processing units have different priority levels, and the highest priority processing unit is selected for operations. In this example, operations with different parameters may perform differently on different processing units, and thus, the highest priority processing unit may not be the priority unit that provides the best, or even optimal, performance. In another example, each operation may be scheduled based on the evaluation of all possible combinations of processing units or on a per-operation basis using a “greedy” technique in which the operation is scheduled for execution on the processing unit which provides the best performance for the operation. However, brute force evaluation of all possible combinations of processing units is generally impractical, as the number of combinations scales exponentially with the number of operations included in the machine learning model (e.g., scales according to Bₙ^{O}^{ₙ}, where Bₙ represents the number of processing units (or backends) in a heterogeneous processing environment and Oₙ represents the number of operations included in the machine learning model). Per-operation selection of processing units may have a smaller search space of Bₙ*Oₙ; however, per-operation selection of processing units may not account for the context switching overhead involved in migrating operations between different processing units, which may exceed savings that may be achieved by migrating operations from a slower processing unit to a faster processing unit.

Aspects of the present disclosure provide techniques for implementing (e.g., scheduling execution of, planning for a deployment of hardware to execute, etc.) a machine learning model in a heterogeneous processing environment that accounts for various overhead costs within the heterogeneous processing environment (e.g., context switching overhead costs or the like). As discussed in further detail below, to efficiently identify the processing unit(s) to be used in performing operations using a machine learning model, a graph representing the machine learning model may be divided into a plurality of subgraphs, and permutations of execution using different processing units may be performed on each subgraph. An execution path may be selected by traversing backwards from the last subgraph to the first subgraph by selecting the execution path with the best execution time or otherwise with the highest performance metrics, conditioned on the previously selected execution paths for lower subgraphs in the graph representing the machine learning model. By doing so, aspects of the present disclosure may reduce the search space over which operations are simulated to a space smaller than Bₙ*Oₙ, which may accelerate the identification of an optimal (or at least preferred) execution path to use in implementing the machine learning model. Further, because these execution paths are selected based on overall performance metrics, overhead such as context switching overhead costs may be considered in identifying the optimal (or at least preferred) execution path to use in implementing the machine learning model. By doing so, aspects of the present disclosure may reduce the amount of computational resources (e.g., processing time, memory, network bandwidth, etc.) involved in performing operations using a machine learning model, which in turn may increase the availability of computing resources for use by other processes executing in the heterogeneous processing environment.

### Example Identification of Execution Paths for Efficient Execution of Operations Using a Machine Learning Model

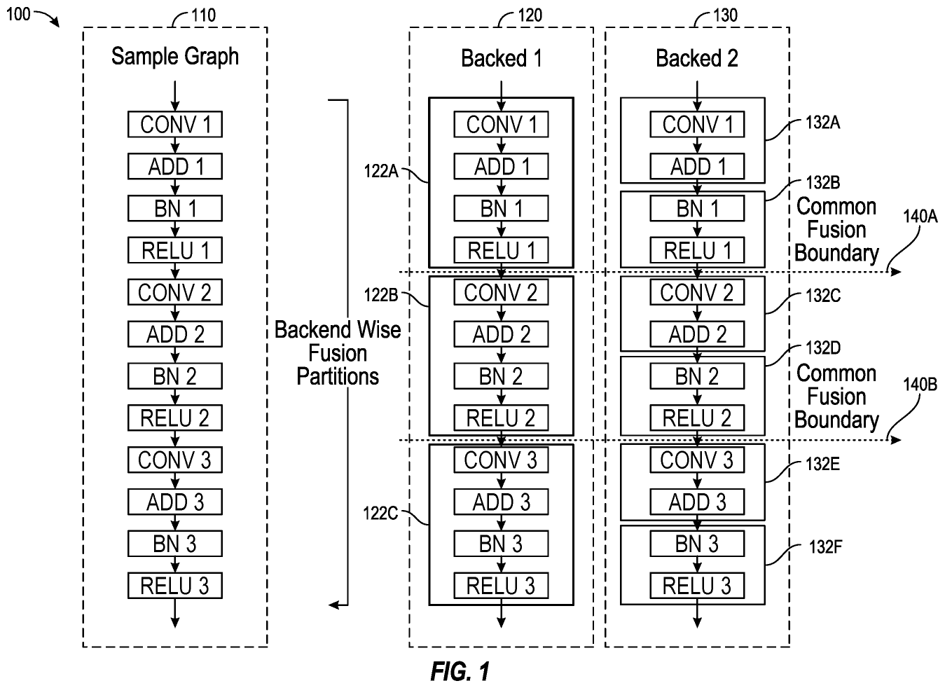

FIG. 1 illustrates an example 100 of partitioning a machine learning model into a plurality of subgraphs, according to aspects of the present disclosure.

As illustrated, a machine learning model may be modeled as a graph 110 identifying operations which are to be performed in order to generate an output of the machine learning model for a given input into the machine learning model (e.g., to generate an inference or other prediction from an input into the machine learning model). The machine learning model may include multiple layers, each of which may include various operations which are to be executed in order to provide an output of the layer that can serve as an input to a subsequent layer or as an output of the machine learning model. For example, the machine learning model modeled as the graph 110 includes three layers. Each of these layers includes a convolution operation (labeled “CONV [X],” where [X] represents a layer number), an addition operation (labeled “ADD [X]”), a batch normalization operation (labeled “BN [X]”), and an activation operation (in this example, activation via a rectified linear unit, labeled “RELU [X},” though it should be understood that other activation operations may be contemplated). It should be recognized that the graph 110 is but an example of a graph representing a machine learning model, and a graph representing a machine learning model may include any number of layers, with each layer including any combination of relevant operations.

To generate a set of subgraphs which can be used to simulate the performance of a machine learning model across different processing units in a heterogeneous processing environment, the graph 110 can be partitioned into a first set of subgraphs 120 for a first processing unit (labeled “Backend 1” in FIG. 1) and a second set of subgraphs 130 for a second processing unit (labeled “Backend 2” in FIG. 1). While FIG. 1 and the subsequent discussion herein describes the generation of an execution path for a machine learning model across two processing units, it should be recognized that the heterogeneous processing environment may include any number of processing units over which execution of machine learning model operations may be distributed.

As illustrated, for the first processing unit, the first set of subgraphs 120 includes a first subgraph 122A, a second subgraph 122B, and a third subgraph 122C. Each of the first subgraph 122A, the second subgraph 122B, and the third subgraph 122C, as illustrated, covers the operations associated with a layer in the machine learning model represented by the graph 110. Meanwhile, for the second processing unit, the second set of subgraphs includes subgraphs 132A through 132F. Each of these subgraphs 132A-132F covers operations associated with part of a layer in the machine learning model represented by the graph 110. For example, as illustrated, the subgraph 132A covers the convolution and addition operations of the first layer of the machine learning model, while the subgraph 132B covers the batch normalization and activation operations of the first layer of the machine learning model. The subgraphs 132C and 132D cover similar portions of the second layer of the machine learning model to the subgraphs 132A and 132B, respectively. Similarly, the subgraphs 132E and 132F cover similar portions of the second layer of the machine learning model to the subgraphs 132A and 132B, respectively.

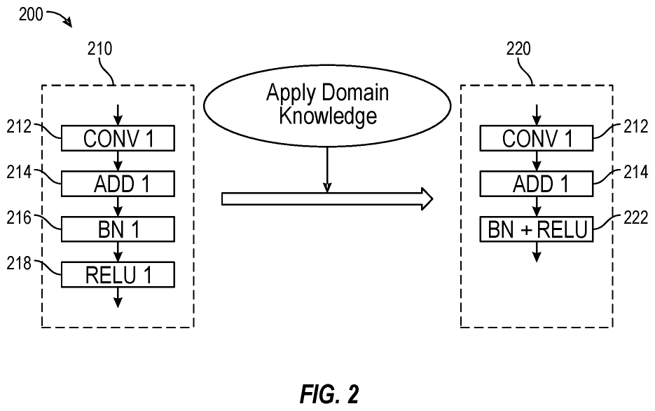

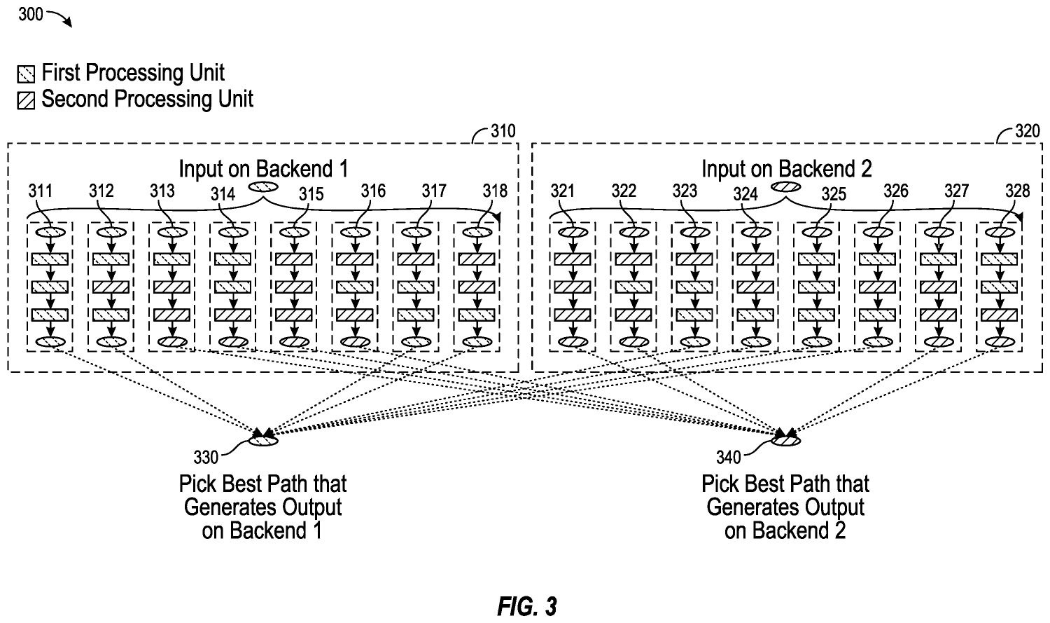

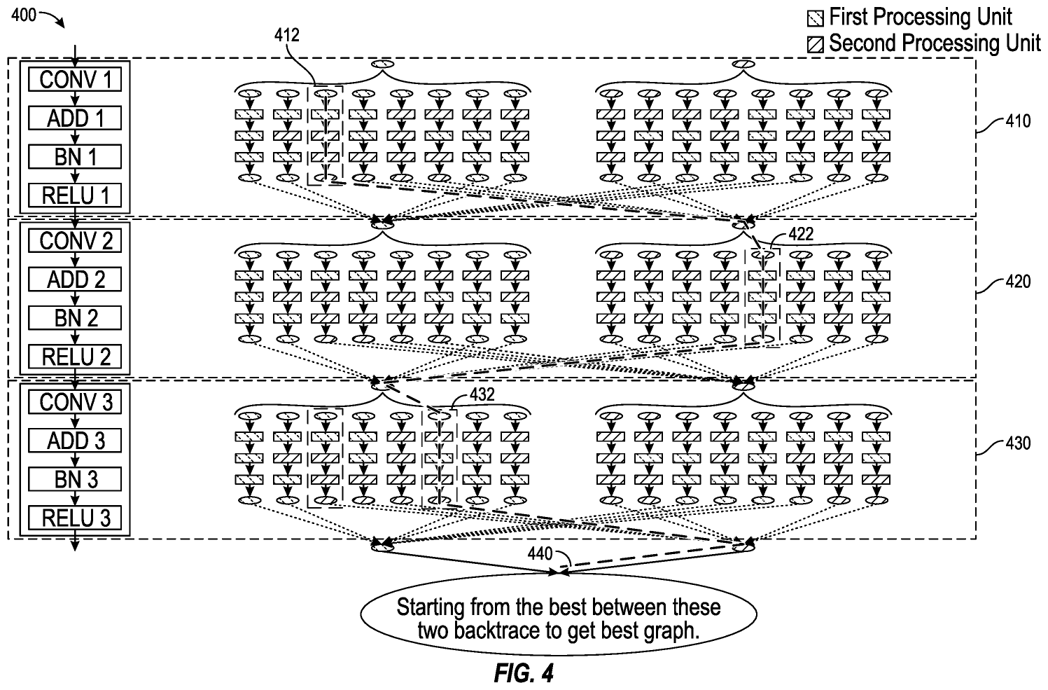

To divide the graph 110 into a set of subgraphs which can be simulated across different processing units, common boundaries 140 may be identified across the first set of subgraphs 120 and the second set of subgraphs 130 (amongst others, not illustrated). Generally, a common boundary 140 may be identified based on the identification of a common output from a subgraph 122 in the first set of subgraphs 120 and a subgraph 132 in the second set of subgraphs 130. In this example, it may be seen that a common output identified in the first set of subgraphs 120 and the second set of subgraphs 130 may be the activation operation of each layer in the machine learning model. Thus, a plurality of subgraphs may be generated from the graph 110 based on the common boundaries 140A and 140B. In the example illustrated in FIG. 1, thus, the graph 110 may be partitioned into three subgraphs based on the common boundaries 140A and 140B: a first subgraph associated with the first layer of the machine learning model, a second subgraph associated with the second layer of the machine learning model, and a third subgraph associated with the third layer of the machine learning model. These subgraphs may be further consolidated, as discussed in further detail below with respect to FIG. 2, and execution paths may be simulated across the processing units in the heterogeneous processing environment, as discussed below with respect to FIGS. 3 and 4.

FIG. 2 illustrates an example modification 200 of a subgraph representing a portion of a machine learning model, according to aspects of the present disclosure.

As illustrated, a subgraph 210 generated from a graph representation of a machine learning model (e.g., the graph 110 illustrated in FIG. 1) includes a plurality of operational blocks. In this example, the subgraph 210 representing a portion of the machine learning model includes a convolutional block 212, an addition block 214, a batch normalization block 216, and a rectified linear unit (ReLU) block 218. To reduce the subgraph 210 into a minimal (or at least a smaller) set of operations which can be distributed amongst processing units in a heterogeneous processing environment, the set of operations in the subgraph 210 may be analyzed using domain-specific knowledge. The domain-specific knowledge may include, for example, information about the operations involved in any of the blocks 212, 214, 216, and 218 and the performance characteristics of these operations. Where consecutive blocks can be executed using the same processing unit without a negative impact on performance, these consecutive blocks can be consolidated into a single block for analysis. For example, as illustrated, it may be determined that the batch normalization block 216 and the rectified linear unit block 218 can be consolidated into a combined block 222. The resulting modified subgraph 220 may thus include three blocks: the convolution block 212, the addition block 214, and the combined batch normalization and rectified linear unit block 222. By reducing the number of blocks included in a subgraph, the number of permutations over which execution by one or more processing units in a heterogeneous processing environment is projected may be reduced.

FIG. 3 illustrates an example simulation 300 of execution paths for a subgraph representing a portion of a machine learning model, according to aspects of the present disclosure.

As illustrated, the simulation 300 for a subgraph may include a simulation based on the input of data into each of a plurality of processing units in the heterogeneous processing environment. For example, the simulation 300 may include a first simulation 310 for a first processing unit and a second simulation 320 for a second processing unit. The first simulation 310 may assume that an input is received at (or otherwise provided to) the first processing unit, and the second simulation 320 may assume that an input is received at (or otherwise provided to) a second processing unit.

Within the first simulation 310 and the second simulation 320, each permutation of executing operations in a subgraph using the processing units in the heterogeneous processing environment may be simulated. The number of permutations may be based on the number of blocks in the subgraph which is being simulated and the number of processing units in the subgraph. Because a subgraph generally includes a small number of operations, it may be computationally feasible to simulate execution speed over each permutation of processing units used to execute different operations in the subgraph. For example, in this example, a subgraph may include three blocks, and there may be two processing units in the heterogeneous processing environment. Thus, the total number of execution paths to be traversed within the first simulation 310 and the second simulation 320 may each be represented by the expression:

$${N}_{b} * {N}_{b}^{{N}_{s}} = {N}_{b}^{( {N}_{s} + 1 )}$$

where N_{b}=2 represents the number of processing units over which execution is simulated and Nₛ=3 represents the number of operations (or blocks) in a subgraph. Each individual subgraph may thus include N_{b}^{N}^{ₛ} permutations of scheduling operations across different processing units in the heterogeneous processing environment. In this example, each of the first simulation 310 and the second simulation 320 may include eight permutations, 311-318 and 321-328, respectively (e.g., 2³=8 permutations for each of the first simulation 310 and the second simulation 320), and thus sixteen permutations in total (2³⁺¹=2⁴=16).

In this example, half of the graph represented by each simulation 310 and 320 may simulate operations resulting in an output 330 generated by the first processing unit in the heterogeneous processing environment, and the other half of the graph may simulate operations resulting in an output 340 generated by the second processing unit in the heterogeneous processing environment. An optimal (or at least preferred) execution path may be selected for the first processing unit as the execution path having the lowest cost (e.g., execution time, resource utilization cost, etc.) from the permutations 311, 312, 317, 318, and 323-326. Similarly, an optimal (or at least preferred) execution path may be selected for the second processing unit as the execution path having the lowest cost from the permutations 313-316, 312, 322, 327, and 328.

FIG. 4 illustrates an example 400 of selecting an execution path from simulations of execution paths through a plurality of subgraphs representing different portions of a machine learning model, according to aspects of the present disclosure.

To simulate a machine learning model represented as a graph (e.g., the graph 110 illustrated in FIG. 1), a plurality of subgraphs may be established representing portions of the machine learning model having a common boundary across the different processing units in the heterogeneous processing environment. In this example, three subgraphs 410, 420, and 430 may be established. The first subgraph 410 may correspond to the first portion of the machine learning model having a common boundary across the first and second processing units (e.g., a portion of the machine learning model including the first convolution, addition, batch normalization, and rectified linear unit blocks); the second subgraph 420 may correspond to the second portion of the machine learning model (e.g., a portion of the machine learning model including the second convolution, addition, batch normalization, and rectified linear unit blocks); and the third subgraph 430 may correspond to the third portion of the machine learning model (e.g., a portion of the machine learning model including the third convolution, addition, batch normalization, and rectified linear unit blocks).

Each of the subgraphs 410, 420, and 430 generally includes simulations based on permutations of the input source processing unit and processing units used to execute each block within a portion of the machine learning model represented by a subgraph. The simulation may be performed for each of the subgraphs 410, 420, and 430 as discussed above with respect to FIG. 3. The total number of permutations within the example 400 may be represented by the expression:

$${\sum }_{i = 0}^{N - 1} ( {N}_{b}^{{N}_{{s}_{i}} + 1} )$$

where N represents the number of subgraphs into which the graph representing a machine learning model is divided.

To generate an execution path for use in implementing the machine learning model at the lowest cost, the graph illustrated in the example 400 may be traversed from the bottom to the top of the graph (e.g., starting with the output of the machine learning model, and traversing backwards until the initial input is received). In this example, the execution path 440 may begin by identifying that within the subgraph 430, the lowest cost execution path is the path 432, in which an input is received at the first processing unit in the heterogeneous processing environment, a convolution operation is performed using the second processing unit, an addition operation is performed using the first processing unit, and a combination of batch normalization and linear processing through a rectified linear unit is performed using the second processing unit.

Based on the identification of the path 432 for inclusion in the execution path 440, an execution path through the subgraph 420 may be identified. Because the path 432 starts with receiving an input at the first processing unit in the heterogeneous processing environment, the execution paths in the second subgraph which are eligible for inclusion in the execution path 440 may be the paths for which an output is generated at the first processing unit (e.g. may exclude any execution paths for which an output is generated at the second processing unit). In this example, thus, the path 422 may be identified as the lowest cost execution path within the subgraph 420 that results in an output being generated at the first processing unit.

Similarly, based on the identification of the paths 422 and 432 for inclusion in the execution path 440, an execution path through the subgraph 410 may be identified. As illustrated, the path 422 begins with an input of data at the second processing unit in the heterogeneous processing environment. Accordingly, selection of an execution path through the subgraph 410 may be conditioned on the selected path resulting in an output generated at the second processing unit, such as the path 412 identified as the lowest cost path satisfying this condition in the subgraph 410.

By selecting processing units for processing different portions of a machine learning model using permutations over subgraphs representing these different portions of a machine learning model, aspects of the present disclosure allow for efficient selection of an optimal (or at least preferred) execution path that considers various overhead costs within a heterogeneous processing environment (e.g., context switching overhead costs). Further, the decomposition of a machine learning model into a plurality of graphs for analysis may reduce the search space complexity over which an optimal (or at least preferred) execution path is identified from

$${N}_{b}^{( {N}_{{s}_{i}} * N )}$$

to

$${\sum }_{i = 0}^{N - 1} ( {N}_{b}^{{N}_{{s}_{i}} + 1} ) ,$$

which represents a significant reduction in the number of simulations to be performed in order to select an optimal (or at least preferred) execution path. For example, for N_{b}=2, Nₛ_{ᵢ}=4, and N=10, the number of execution paths simulated in order to identify an optimal (or at least preferred) execution path for the machine learning model over the processors in the heterogeneous processing environment may be reduced from 240 in an exhaustive search to 10*2⁵=160. Thus, identification of an optimal (or at least preferred) execution path may be simplified from an intractable problem, or a problem that is computationally impractical (if not impossible) to perform, to a problem for which a solution may be efficiently identified.

### Example Operations for Identification of Execution Paths for Efficient Execution of Operations Using a Machine Learning Model

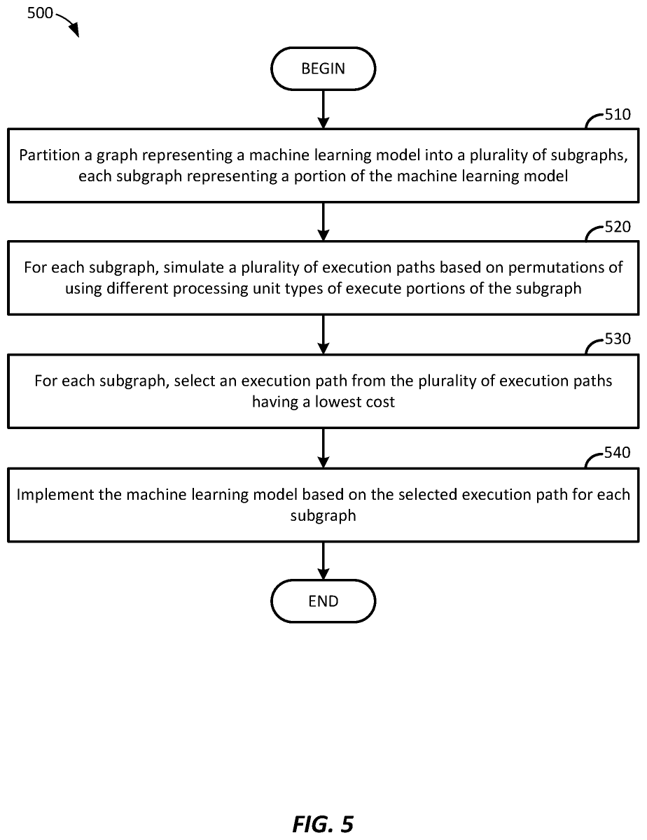

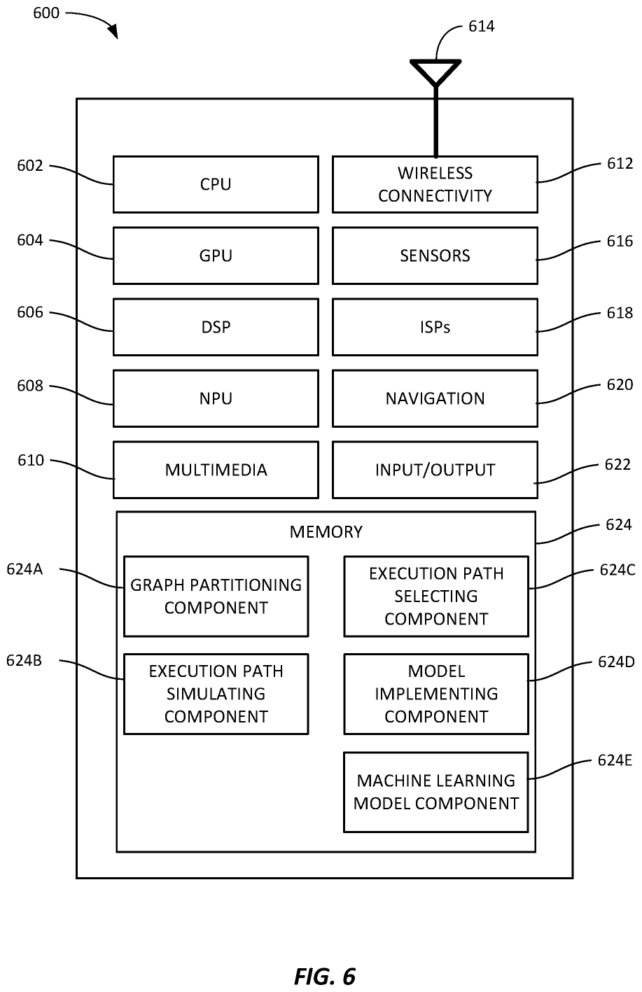

FIG. 5 illustrates example operations 400 for efficiently executing operations using a machine learning model in a heterogeneous processing environment based on selection of execution paths through a plurality of subgraphs representing the machine learning model, according to aspects of the present disclosure. The operations 500 may be performed, for example, by a processing system (e.g., the processing system 600 illustrated in FIG. 6) on which a machine learning model is deployed for use in generating inferences on input data. These processing systems may include, for example, smartphones, autonomous vehicles, computing devices communicatively coupled with robots, and so on.

As illustrated, the operations 500 begin at block 510 with partitioning a graph representing a machine learning model into a plurality of subgraphs. Generally, each subgraph represents a portion of the machine learning model.

In some aspects, partitioning the graph representing the machine learning model into the plurality of subgraphs comprises partitioning the graph representing the machine learning model into a first set of subgraphs associated with a first processing unit type of the different processing unit types and a second set of subgraphs associated with a second processing unit type of the different processing unit types. In some aspects, the first set of subgraphs and the second set of subgraphs comprise graphs generated based on a common fusion boundary across a first processing system associated with the first processing unit type and a second processing system associated with the second processing unit type. The common fusion boundary may include, for example, a point in the machine learning model at which a subgraph in the first set of subgraphs and a corresponding subgraph in the second set of subgraphs output a common output for ingestion into a subsequent portion of the machine learning model.

At block 520, the operations 500 proceed with simulating, for each subgraph, a plurality of execution paths based on permutations of using different processing unit types to execute portions of the subgraph and starting with each input source processing unit type selected from the different processing unit types.

In some aspects, simulating the plurality of execution paths for each subgraph comprises simulating an execution time for executing operations identified in the subgraph including context switching time for transitions from a first processing unit type of the different processing unit types to a second processing unit type of the different processing unit types. Generally, the simulated execution time may include both time during which processing units are active in performing operations on data ingested into or derived from the data ingested into one or more of the processing units in a heterogeneous processing environment and time during which context switching between different processing units occurs.

At block 530, the operations 500 proceed with selecting, for each subgraph, an execution path from the plurality of execution paths having a lowest cost.

In some aspects, selecting the execution path for each subgraph comprises selecting the execution path having the lowest cost for each subgraph based on a backwards traversal of a graph representing the simulated plurality of execution paths for the plurality of subgraphs representing the machine learning model

At block 540, the operations 500 proceed with implementing the machine learning model based on the selected execution path for each subgraph.

In some aspects, the operations 500 further include modifying a subgraph from the plurality of subgraphs based on combining consecutive portions of a subgraph representing operations for which execution should remain with the same processing unit type, wherein the plurality of execution paths are simulated based on the modified subgraph.

In some aspects, the operations 500 further include generating an inference using the implemented machine learning model based on an input into the implemented machine learning model and the selected execution path for each subgraph.

In some aspects, further downstream actions may be taken, or at least initiated, based on the inference generated using the implemented machine learning model. For example, based on detecting objects within a field of travel, one or more control signals may be generated to control the motion of an autonomous vehicle, a robotic arm, or the like, in order to minimize, or at least reduce, the likelihood that the autonomous vehicle, robotic arm, etc. will collide with the detected objects. In another example, based on predicting that an object will travel in a particular direction relative to an autonomous vehicle, robotic arm, or the like, one or more control signals may be generated to cause the autonomous vehicle, robotic arm, etc. to change a direction of motion and/or the speed at which such motion is performed in order to in order to minimize, or at least reduce, the likelihood that the autonomous vehicle, robotic arm, etc. will move in conflict with the object for which future motion is predicted.

In yet another example, based on semantic segmentation of an image into classes of objects that are of interest and classes of objects that can be ignored (e.g., foreground content and background content, or moving content and static content), image data can be compressed using varying compression schemes with varying degrees of compression loss (e.g., such that foreground content or moving content is compressed using lossless or near-lossless compression schemes, while background content or static content is compressed using lossier compression schemes). It should be noted that the foregoing are but examples of additional actions that can be performed based on at least one of the first output and the second output, and other actions may be contemplated based on the environment in which a neural network is deployed.

In some aspects, the different processing unit types comprise two or more of a central processing unit (CPU), a graphics processing unit (GPU), or a neural processing unit (NPU).

### Example Processing Systems for Identification of Execution Paths for Efficient Execution of Operations Using a Machine Learning Model

FIG. 6 depicts an example processing system 600 for efficient execution of operations using a machine learning model based on simulation of execution paths through a plurality of subgraphs representing portions of the machine learning model, such as described herein for example with respect to FIG. 5.

The processing system 600 includes at least one central processing unit (CPU) 602, which in some examples may be a multi-core CPU. Instructions executed at the CPU 602 may be loaded, for example, from a program memory associated with the CPU 602 or may be loaded from a memory partition (e.g., of memory 624).

The processing system 600 also includes additional processing components tailored to specific functions, such as a graphics processing unit (GPU) 604, a digital signal processor (DSP) 606, a neural processing unit (NPU) 608, a multimedia processing unit 610, and a connectivity component 612.

An NPU, such as the NPU 608, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 608 is a part of one or more of the CPU 602, the GPU 604, and/or the DSP 606. These may be located on a user equipment (UE) in a wireless communication system or another computing device.

In some examples, the connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 612 may be further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a graph partitioning component 624A, an execution path simulating component 624B, an execution path selecting component 624C, a model implementing component 624D, and a machine learning model component 624E. The depicted components, and others not depicted, may be configured to perform various aspects of the methods described herein.

Generally, the processing system 600 and/or components thereof may be configured to perform the methods described herein.

### Example Clauses

Implementation details of various aspects of the present disclosure are set forth in the following numbered clauses:
Clause 1: A processor-implemented method, comprising: partitioning a graph representing a machine learning model into a plurality of subgraphs, each subgraph representing a portion of the machine learning model; for each subgraph, simulating a plurality of execution paths based on permutations of using different processing unit types to execute portions of the subgraph and starting with each input source processing unit type selected from the different processing unit types; for each subgraph, selecting an execution path from the plurality of execution paths having a lowest cost; and implementing the machine learning model based on the selected execution path for each subgraph.
Clause 2: The method of Clause 1, wherein partitioning the graph representing the machine learning model into the plurality of subgraphs comprises partitioning the graph representing the machine learning model into a first set of subgraphs associated with a first processing unit type of the different processing unit types and a second set of subgraphs associated with a second processing unit type of the different processing unit types.
Clause 3: The method of Clause 2, wherein the first set of subgraphs and the second set of subgraphs comprise graphs generated based on a common fusion boundary across a first processing system associated with the first processing unit type and a second processing system associated with the second processing unit type.
Clause 4: The method of Clause 3, wherein the common fusion boundary comprises a point in the machine learning model at which a subgraph in the first set of subgraphs and a corresponding subgraph in the second set of subgraphs output a common output for ingestion into a subsequent portion of the machine learning model.
Clause 5: The method of any of Clauses 1 through 4, wherein simulating the plurality of execution paths for each subgraph comprises simulating an execution time for executing operations identified in the subgraph including context switching time for transitions from a first processing unit type of the different processing unit types to a second processing unit type of the different processing unit types.
Clause 6: The method of any of Clauses 1 through 5, further comprising modifying a subgraph from the plurality of subgraphs based on combining consecutive portions of a subgraph representing operations for which execution should remain with the same processing unit type, wherein the plurality of execution paths are simulated based on the modified subgraph.
Clause 7: The method of any of Clauses 1 through 6, wherein selecting the execution path for each subgraph comprises selecting the execution path having the lowest cost for each subgraph based on a backwards traversal of a graph representing the simulated plurality of execution paths for the plurality of subgraphs representing the machine learning model.
Clause 8: The method of any of Clauses 1 through 7, further comprising generating an inference using the implemented machine learning model based on an input into the implemented machine learning model and the selected execution path for each subgraph.
Clause 9: The method of any of Clauses 1 through 8, wherein the different processing unit types comprise two or more of a central processing unit (CPU), a graphics processing unit (GPU), or a neural processing unit (NPU).
Clause 10: A processing system, comprising: a memory having executable instructions stored thereon; and one or more processors configured to execute the executable instructions in order to cause the processing system to perform the operations of any of Clauses 1 through 9.
Clause 11: A system comprising means for performing the operations of any of Clauses 1 through 9.
Clause 12: A computer-readable medium having executable instructions stored thereon which, when executed by one or more processors, cause the one or more processors to perform the operations of any of Clauses 1 through 9.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
partitioning a graph representing a machine learning model into a plurality of subgraphs, each subgraph representing a portion of the machine learning model;
for each subgraph, simulating a plurality of execution paths based on permutations of using different processing unit types to execute portions of the subgraph and starting with each input source processing unit type selected from the different processing unit types;
for each subgraph, selecting an execution path from the plurality of execution paths having a lowest cost; and
implementing the machine learning model based on the selected execution path for each subgraph.

2. The method of claim 1, wherein partitioning the graph representing the machine learning model into the plurality of subgraphs comprises partitioning the graph representing the machine learning model into a first set of subgraphs associated with a first processing unit type of the different processing unit types and a second set of subgraphs associated with a second processing unit type of the different processing unit types.

3. The method of claim 2, wherein the first set of subgraphs and the second set of subgraphs comprise graphs generated based on a common fusion boundary across a first processing system associated with the first processing unit type and a second processing system associated with the second processing unit type.

4. The method of claim 3, wherein the common fusion boundary comprises a point in the machine learning model at which a subgraph in the first set of subgraphs and a corresponding subgraph in the second set of subgraphs output a common output for ingestion into a subsequent portion of the machine learning model.

5. The method of claim 1, wherein simulating the plurality of execution paths for each subgraph comprises simulating an execution time for executing operations identified in the subgraph including context switching time for transitions from a first processing unit type of the different processing unit types to a second processing unit type of the different processing unit types.

6. The method of claim 1, further comprising modifying a subgraph from the plurality of subgraphs based on combining consecutive portions of a subgraph representing operations for which execution should remain with the same processing unit type, wherein the plurality of execution paths are simulated based on the modified subgraph.

7. The method of claim 1, wherein selecting the execution path for each subgraph comprises selecting the execution path having the lowest cost for each subgraph based on a backwards traversal of a graph representing the simulated plurality of execution paths for the plurality of subgraphs representing the machine learning model.

8. The method of claim 1, further comprising generating an inference using the implemented machine learning model based on an input into the implemented machine learning model and the selected execution path for each subgraph.

9. The method of claim 1, wherein the different processing unit types comprise two or more of a central processing unit (CPU), a graphics processing unit (GPU), or a neural processing unit (NPU).

10. A processing system, comprising:
at least one memory having executable instructions stored thereon; and
one or more processors configured to execute the executable instructions to cause the processing system to:
partition a graph representing a machine learning model into a plurality of subgraphs, each subgraph representing a portion of the machine learning model;
for each subgraph, simulate a plurality of execution paths based on permutations of using different processing unit types to execute portions of the subgraph and starting with each input source processing unit type selected from the different processing unit types;
for each subgraph, select an execution path from the plurality of execution paths having a lowest cost; and
implement the machine learning model based on the selected execution path for each subgraph.

11. The processing system of claim 10, wherein to partition the graph representing the machine learning model into the plurality of subgraphs, the one or more processors are configured to cause the processing system to partition the graph representing the machine learning model into a first set of subgraphs associated with a first processing unit type of the different processing unit types and a second set of subgraphs associated with a second processing unit type of the different processing unit types.

12. The processing system of claim 11, wherein the first set of subgraphs and the second set of subgraphs comprise graphs generated based on a common fusion boundary across a first processing system associated with the first processing unit type and a second processing system associated with the second processing unit type.

13. The processing system of claim 12, wherein the common fusion boundary comprises a point in the machine learning model at which a subgraph in the first set of subgraphs and a corresponding subgraph in the second set of subgraphs output a common output for ingestion into a subsequent portion of the machine learning model.

14. The processing system of claim 10, wherein to simulate the plurality of execution paths for each subgraph, the one or more processors are configured to cause the processing system to simulate an execution time for executing operations identified in the subgraph including context switching time for transitions from a first processing unit type of the different processing unit types to a second processing unit type of the different processing unit types.

15. The processing system of claim 10, wherein the one or more processors are further configured to cause the processing system to modify a subgraph from the plurality of subgraphs based on combining consecutive portions of a subgraph representing operations for which execution should remain with the same processing unit type, wherein the plurality of execution paths are simulated based on the modified subgraph.

16. The processing system of claim 10, wherein to select the execution path for each subgraph, the one or more processors are configured to cause the processing system to select the execution path having the lowest cost for each subgraph based on a backwards traversal of a graph representing the simulated plurality of execution paths for the plurality of subgraphs representing the machine learning model.

17. The processing system of claim 10, wherein the one or more processors are further configured to cause the processing system to generate an inference using the implemented machine learning model based on an input into the implemented machine learning model and the selected execution path for each subgraph.

18. The processing system of claim 10, wherein the different processing unit types comprise two or more of a central processing unit (CPU), a graphics processing unit (GPU), or a neural processing unit (NPU).

19. A processing system, comprising:
means for partitioning a graph representing a machine learning model into a plurality of subgraphs, each subgraph representing a portion of the machine learning model;
means for simulating, for each subgraph, a plurality of execution paths based on permutations of using different processing unit types to execute portions of the subgraph and starting with each input source processing unit type selected from the different processing unit types;
means for selecting, for each subgraph, an execution path from the plurality of execution paths having a lowest cost; and
means for implementing the machine learning model based on the selected execution path for each subgraph.

20. The processing system of claim 19, wherein the means for partitioning the graph representing the machine learning model into the plurality of subgraphs comprises means for partitioning the graph representing the machine learning model into a first set of subgraphs associated with a first processing unit type of the different processing unit types and a second set of subgraphs associated with a second processing unit type of the different processing unit types.

21. The processing system of claim 20, wherein the first set of subgraphs and the second set of subgraphs comprise graphs generated based on a common fusion boundary across a first processing system associated with the first processing unit type and a second processing system associated with the second processing unit type.

22. The processing system of claim 21, wherein the common fusion boundary comprises a point in the machine learning model at which a subgraph in the first set of subgraphs and a corresponding subgraph in the second set of subgraphs output a common output for ingestion into a subsequent portion of the machine learning model.

23. The processing system of claim 19, wherein the means for simulating the plurality of execution paths for each subgraph comprises means for simulating an execution time for executing operations identified in the subgraph including context switching time for transitions from a first processing unit type of the different processing unit types to a second processing unit type of the different processing unit types.

24. The processing system of claim 19, further comprising means for modifying a subgraph from the plurality of subgraphs based on combining consecutive portions of a subgraph representing operations for which execution should remain with the same processing unit type, wherein the plurality of execution paths are simulated based on the modified subgraph.

25. The processing system of claim 19, wherein the means for selecting the execution path for each subgraph comprises means for selecting the execution path having the lowest cost for each subgraph based on a backwards traversal of a graph representing the simulated plurality of execution paths for the plurality of subgraphs representing the machine learning model.

26. The processing system of claim 19, further comprising means for generating an inference using the implemented machine learning model based on an input into the implemented machine learning model and the selected execution path for each subgraph.

27. The processing system of claim 19, wherein the different processing unit types comprise two or more of a central processing unit (CPU), a graphics processing unit (GPU), or a neural processing unit (NPU).

28. A non-transitory computer-readable medium having executable instructions stored thereon which, when executed by one or more processors, perform an operation comprising:
partitioning a graph representing a machine learning model into a plurality of subgraphs, each subgraph representing a portion of the machine learning model;
for each subgraph, simulating a plurality of execution paths based on permutations of using different processing unit types to execute portions of the subgraph and starting with each input source processing unit type selected from the different processing unit types;
for each subgraph, selecting an execution path from the plurality of execution paths having a lowest cost; and
implementing the machine learning model based on the selected execution path for each subgraph.
